(19) United States
(12) Patent Application Publication
(10) Pub. No.: US 2010/0172813 A1
(43) Pub. Date: Jul. 8, 2010

(54) DEVICE AND METHOD FOR REDUCING CO2-EMISSIONS FROM THE WASTE GASES OF COMBUSTION PLANTS

(76) Inventors: Jewgeni Nazarko, Dueren (DE); Ernst Riensche, Juelich (DE); Ludger Blum, Juelich (DE); Reinhard Menzer, Juelich (DE); Wilhelm Albert Meulenberg, Vijlen (NL); Martin Bram, Juelich (DE)

Correspondence Address: JORDAN AND HAMBURG LLP, 122 EAST 42ND STREET, SUITE 4000, NEW YORK, NY, 10168, US

(21) Appl. No.: 12/451,966

(22) PCT Filed: May 30, 2008
(86) PCT No.: PCT/DE2008/000907

§ 371 Date: Dec. 8, 2009

(30) Foreign Application Priority Data
Jun. 11, 2007 (DE) 10-2007-027-388.8

(51) Int. Cl. B01D 53/62; B01D 53/86

(52) U.S. Cl. 423/232; 422/168; 422/173

(57) ABSTRACT

A method for separating carbon dioxide from a flue gas using a membrane (membrane module) is characterized in that the flue gas is at temperatures above the condensation point of the water vapor before entering the membrane separation stage. In this way, condensation of any potentially entrained water vapor out of the flue gas is avoided, so as to consistently prevent clogging of the membrane pores. The high temperatures can be achieved in different ways. The temperature of the flue gas can easily be increased to the necessary temperatures by way of an upstream heat exchanger or a burner. A compressor, which is connected upstream of the membrane module and also advantageously increases the CO₂ partial pressure, brings about the necessary temperature increase at the same time. As a further alternative for the invention, the CO₂ separation is performed even before desulfurizing the flue gas. This notably has the advantage of the flue gas in this process stage still being at temperatures above the condensation point of the water vapor, and thus not having to be heated separately, in addition to which, it generally carries little water vapor at this stage of the scrubbing operation.

The invention relates to methods for reducing CO₂ emissions from the waste gases of combustion plants, particularly from flue gases of energy conversion plants, using membranes. The invention further relates to devices suited for performing these methods.

### STATE OF THE ART

One of the most significant sources of increases in atmospheric carbon dioxide concentrations is the combustion of fossil fuels in combustion plants with the goal of producing energy. Thus, attempts have been undertaken to separate CO₂ from the combustion of fossil fuels and thereafter store it, so as not to release it into the atmosphere. The reasons for these endeavors are the greenhouse effect and resulting global warming.

Among various conceivable methods, at present, three basic approaches to separation of carbon dioxide are being pursued, which differ in the positioning of the separation step with respect to the energy conversion process. These approaches are CO₂ separation after energy conversion, CO₂ separation prior to energy conversion, and production of a flue gas rich in CO₂ by way of energy conversion in an enriched oxygen atmosphere.

As an end-of-pipe solution, the approach of CO₂ separation after energy conversion is advantageous in that the CO₂ separation step itself has little influence on the availability of the energy conversion plant [10] and allows for retrofitting of existing plants.

In light of the higher CO₂ concentrations in the flue gas and the more complex downstream flue gas scrubbing step, the state of the art will be described by way of the example of a coal-fired steam power plant.

In the coal-fired power plants according to the prior art, the flue gas leaves the power plant after nitrogen oxide reduction/dedusting and desulfurization. As a result, the CO₂, which depending on the respective power plant, fuel and/or firing conditions, constitutes no more than 15% by volume, reaches the atmosphere. In order to separate the CO₂, the flue gas is conducted through a scrubbing tower after optionally adapted desulfurization, which may depend on the SO₂ content of the flue gas [1, 3, 8]. There, the CO₂ is absorbed, for example, by an atomized amine-based scrubbing solution. In a second step, the scrubbing solution can be regenerated in a separator (stripper) by heating, thereby releasing the CO₂ in a concentrated form, which can then be stored. The reduced CO₂ scrubbing solution can then once again be used for absorption [2].

However, the disadvantages here are:
the decrease in the net efficiency of the power plant as a result of tapping the low-pressure vapor for regenerating the scrubbing solution, and as a result of running the electrical equipment of the scrubbing plant [1, 6, 7, 8];
the consumption of scrubbing solution, due to irreversible reactions of the components of the scrubbing solution with the components of the flue gas, and also due to degradation and evaporation of the scrubbing solution [1, 3, 5, 8];
the release of potentially altered scrubbing solution components into the atmosphere and the need for elimination of additional waste products requiring special supervision from the processing of the scrubbing solution and the decomposition and/or reaction products [1, 6].

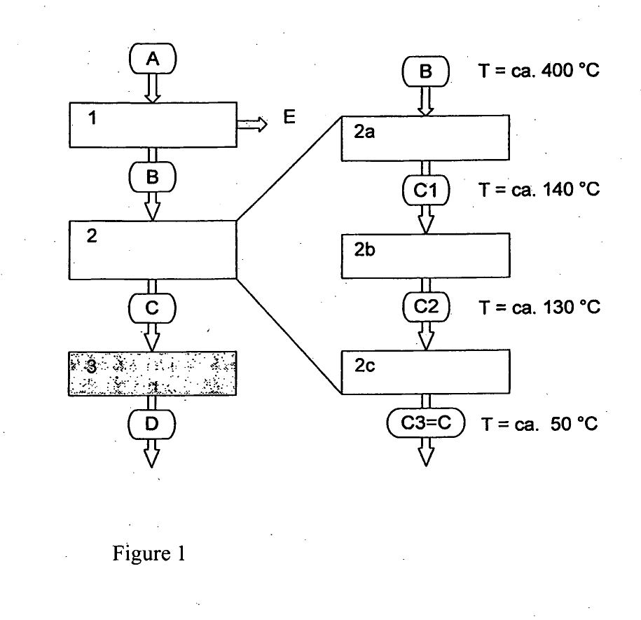

Furthermore, various gas separation methods are known for separating CO₂ from flue gases, such as using membranes having pore diameters of less than 1 μm [4]. With these methods it is assumed that the CO₂ separation is performed after scrubbing the flue gas, in a similar manner to CO₂ separation by way of the chemical adsorption described above (FIG. 1).

In the process, flue gas desulfurization is an important part of flue gas scrubbing. For large-scale combustion plants fired with solid fuels, the dominant flue gas desulfurization method at the present time is desulfurization by way of the limestone scrubbing processes using limestone (CaCO₃), while simultaneously producing gypsum (CaSO₄.2H₂O) [9]. As a result of the wet scrubbing process, the flue gas is substantially saturated with water vapor when exiting the flue gas desulfurization plant at a temperature of approximately 40-70° C. The temperature level depends on the power plant parameters. In analysis hereafter, the temperature of the flue gas after desulfurization is assumed to be 50° C. When the flue gas decarbonization step is positioned downstream of the wet flue gas desulfurization step, using a membrane, depending on the membrane material, the pores of the membrane may be disadvantageously clogged by condensing water because the temperature is below the condensation point of the water vapor.

### PROBLEM AND SOLUTION

It is an object of the invention to provide a method which allows for a reduction in CO₂ emissions from the waste gases of combustion plants in a simple and cost-effective manner.

It is a further object of the invention to provide a suitable device for performing the method mentioned above.

The objects of the invention are achieved by a method according to the main claim and by a device comprising the collective characteristics of the additional independent claim. Advantageous embodiments are apparent from the dependent claims referring to these claims.

### SUBJECT MATTER OF THE INVENTION

The invention relates to various methods for reducing CO₂ emissions from the waste gases of combustion plants, and particularly from flue gases of energy conversion plants, using membranes. The invention further relates to devices suited for performing these methods.

Hereafter, a combustion plant shall be understood as any plant in which a gaseous, liquid and/or solid fuel, regardless of the origin thereof, is oxidized or partially oxidized so as to use the heat generated, including combustion plants for the treatment of waste products and co-incineration plants, as well as electrochemical oxidation facilities (such as fuel cells). These include, for example, gas burners operated with natural gas, liquefied petroleum gas, city gas, or landfill gas, oil burners operated, for example, with crude oil, heating oil or alcohols, as well as grate firing of clumped or pelletized fuels, such as gassy coal or wood chips, fluidized bed combustion processes or coal dust firing. This definition covers all associated devices and systems of a combustion plant. Such plants comprise both fixed and movable technical installations.

Flue gas is the carrier gas having solid, liquid and/or gaseous air pollutants. Air pollution includes changes in the natural composition of the air, particularly by smoke, ash, soot, dust, gases, aerosols, vapors, or odors.

The idea of the invention is based on optimizing the ambient parameters of the flue gas for the separation of CO₂ (decarbonization method) using a membrane, so that disadvantageous clogging of the membrane pores by condensed water can be prevented. In particular three different alternatives lend themselves to this process.

In a first embodiment, the CO₂ separation (flue gas decarbonization) process step is advantageously integrated into an existing flue gas scrubbing step, for example in a coal-fired steam power plant, so that it is performed prior to flue gas desulfurization, but advantageously after dedusting. This has the advantage that, after dedusting, the flue gas is at a temperature of approximately 120-150° C., so that the water vapor contained therein is in a state above the condensation point. As a result, there is no risk of water condensing out, since the dedusted flue gas contains less water vapor than after desulfurization. The water vapor content of the flue gas after dedusting can only be conditionally generalized, since the water content is influenced by the water content of the fuel employed and the procedure up to this point. Wet desulfurization of the flue gas using the limestone scrubbing process introduces, for example, approximately 15 kg of water per kg of reduced SO₂ into the flue gas flow [9], and thus the water vapor concentration may, for example, be 10% by volume.

According to a second embodiment of the invention, the flue gas decarbonization step is positioned downstream of the complete flue gas scrubbing step, in a manner similar to the prior art. However, in contrast, the flue gas is first heated so that the temperature is clearly below the condensation point of the water vapor, in order to prevent condensation of the water. Heating can advantageously be achieved by introducing external heat or by way of a heat exchanger.

This procedure can be implemented as an independent alternative, or in the event that the alternative described above is no longer possible. This may become necessary, for example if, when the membrane module is positioned between the flue gas dedusting and the flue gas desulfurization steps, the membrane material is irreparably damaged by the residual dust and gaseous pollutants present in the nitrogen oxide-reduced and dedusted flue gas.

This second alternative is particularly easy to implement because it only requires installation of a heat exchanger in the line between the known steps of flue gas desulfurization and flue gas decarbonization; the overall arrangement of the steps, however, can remain unchanged.

A further embodiment, which is similar to the second embodiment, proposes a pressure increase instead of a temperature increase. This means that the flue gas decarbonization step is once again positioned downstream of the wet flue gas desulfurization step. However, a compressor interposed therebetween ensures that the moist flue gas is first compressed, whereby the temperature is also automatically increased. A further positive side effect of this alternative is that the CO₂ partial pressure in the scrubbed flue gas is advantageously increased, which is particularly advantageous for the subsequent CO₂ separation. Compression is to at least a pressure at which the condensation point of the water vapor that is heated thereby is exceeded.

Regardless of the particular embodiment of the invention, it is advantageous in any case to design the membrane module for separating CO₂ in multiple stages rather than a single stage. By arranging multiple, membrane separation stages, which may be different, it is possible to achieve the highest possible degree of separation and, at the same time, the highest possible purity of the separated component, which is in this case is CO₂, with the lowest possible energy expenditure, which is to say the highest possible net efficiency.

### SPECIFIC DESCRIPTION

The invention will be explained in more detail hereafter with reference to exemplary embodiments, without thereby limiting the scope of protection. The person skilled in the relevant art will recognize these or other analogous modifications as part of the invention.

In the figures, the ovals denote the following media:

A Fuel

B Raw flue gas

C Scrubbed flue gas, wherein a differentiation is made between:
C1 Nitrogen oxide-reduced flue gas,
C2 Nitrogen oxide-reduced and dedusted flue gas,
C3 Nitrogen oxide-reduced, dedusted and desulfurized flue gas, and
C4 Nitrogen oxide-reduced, dedusted and decarbonized flue gas,

D Pure flue gas=nitrogen oxide-reduced, dedusted, desulfurized and decarbonized flue gas,

E Electricity

The rectangles denote the individual steps:

1 Production of electricity

2 Flue gas scrubbing, presently comprising
2a Nitrogen oxide reduction,
2b Dedusting, and
2c Desulfurization

3 CO₂ separation (decarbonization) using membrane module

4 Heat transfer

5 Pressure increase

FIG. 1 shows a diagram for an energy conversion process, which in this case is energy production with CO₂ separation (decarbonization) after flue gas scrubbing, according to the prior art (left side). Flue gas scrubbing of a large-scale combustion plant fired with solid fuel, corresponding to the present state of the art, comprises nitrogen oxide reduction, dedusting, and desulfurization, in that order (right side). The right side of FIG. 1, which shows the flue gas scrubbing process step in more detail, additionally provides an overview of the typical temperature profile of the flue gas between the flue gas scrubbing processes.

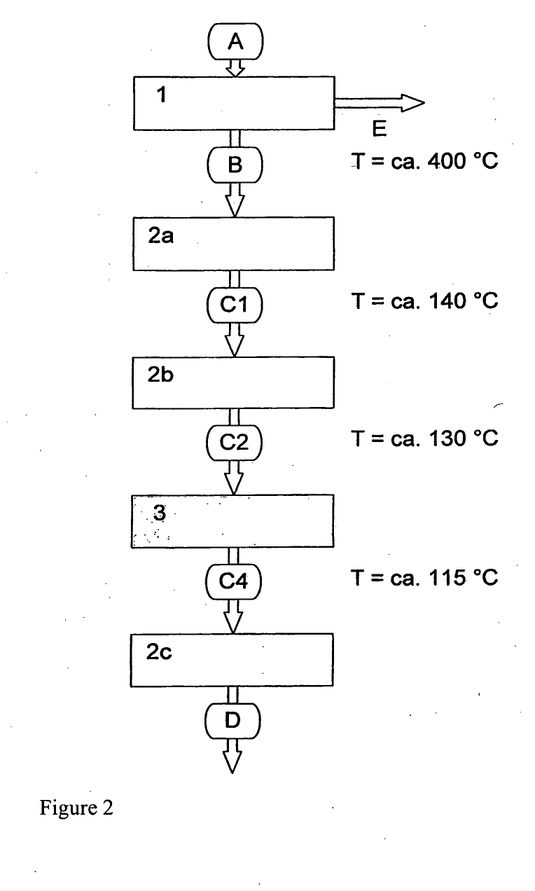

FIG. 2 shows a diagram for an energy conversion process, comprising an integrated flue gas decarbonization step after the flue gas dedusting step, which corresponds to a first embodiment of the invention. This example can be adapted, for example, for a coal power plant. By positioning the membrane module for the CO₂ separation (decarbonization) step between the flue gas dedusting and flue gas desulfurization steps, where the substantially depressurized flue gas typically is at a temperature of approximately 130° C., the problem of water condensation in the pores of the membrane is systematically eliminated.

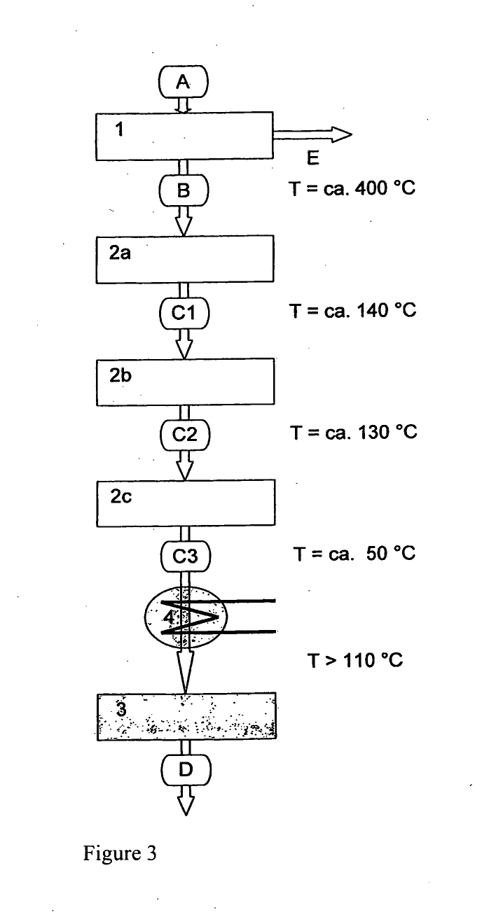

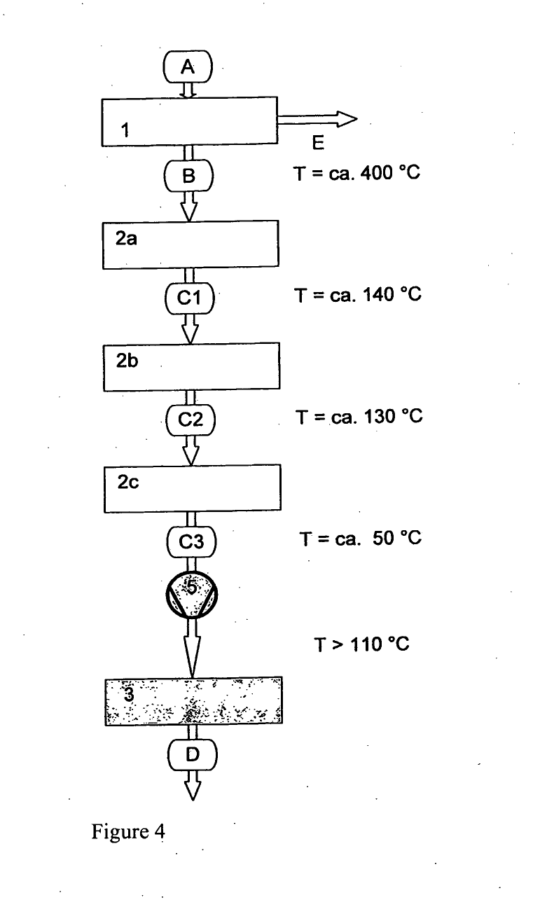

A second embodiment of the invention is shown in FIG. 3. Here, as in the prior art, the flue gas decarbonization step is positioned downstream of the complete flue gas scrubbing step, with the difference that, in order to prevent the condensation of water out of the flue gas, which is substantially saturated at 50° C., the flue gas is first heated so that the condensation point of the water vapor is clearly exceeded. Heating can advantageously be achieved by the application of heat or by way of a heat exchanger. In this example, substantially depressurized flue gas is heated to temperatures above 110° C.

This alternative is suitable either independently, or if the alternative mentioned above is no longer possible. This may be the case, for example, if when the membrane module is positioned between the flue gas dedusting and the flue gas desulfurization steps, the membrane material is irreparably damaged by the residual dust and gaseous pollutants present in the nitrogen oxide-reduced and dedusted flue gas.

In order to prevent clogging of the membrane by the condensing water vapor, the CO₂-containing flue gas to be scrubbed is brought to a higher temperature level, by way of the reheating step, so that the condensation point of the water vapor is exceeded. A variety of systems are available for this, such as applying heat by way of external energy or by way of heat exchange with unscrubbed flue gas.

In a third embodiment of the invention, the flue gas decarbonization step is likewise positioned downstream of the flue gas scrubbing step. Instead of heat input or a heat exchanger, in this case, a pressure increase step is interposed. The pressure increase to the flue gas exiting the flue gas scrubbing step is implemented by a compressor. Compressing is carried out at least at such a pressure that the condensation point of the water vapor heated thereby is exceeded.

A further advantageous side effect of this alternative is that, in this case, the CO₂ partial pressure in the scrubbed flue gas is advantageously increased, which is particularly advantageous for the subsequent CO₂ separation step.

### LITERATURE CITED IN THIS APPLICATION

[1] CHAPEL, D. G., MARIZ, C. L. & ERNEST, J. (1999) Recovery of CO₂ from Flue Gases: Commercial Trends, Canadian Society of Chemical Engineers Saskatoon, Saskatchewan, Canada.
[2] KOHL, A. L. & NIELSEN, R. B. (1997) Gas Purification, Houston, Gulf Publishing Company.
[3] KOSS, U. (2005) Kraftwerkslinien and Abscheideoptionen—Eine Diskussion der grundlegenden Strategien zur CO₂-Abscheidung in CCS-Kraftwerken [Power plant lines and separation options—A discussion of the fundamental strategies for CO₂ separation in CCS (carbon capture & storage) power plants], IN KUCKSHINRICHS, W., MARKEWITZ, P. & HAKE, J.-F. (Eds.) CO₂-Abscheidung und -Speicherung: Eine Zukunftsoption für die deutsche Klimaschutzstrategie? [CO₂ separation and storage: A future option for the German climate protection strategy?], Jülich, Forschungszentrum Jülich GmbH, System Research and Technological Development.
[4] MEULENBERG, W. A., VAN DER DANK, G. J. W., RIENSCHE, E. & BLUM, L. (2005) CO₂-Abscheidung mit keramischen Membranen und konkurrierenden Verfahren [CO₂ separation using ceramic materials and competing methods], IN KUCKSHINRICHS, W., MARKEWITZ, P. & HAKE, J.-F. (Eds.) CO₂-Abscheidung und -Speicherung: Eine Zukunftsoption für die deutsche Klimaschutzstrategie? [CO₂ separation and storage: A future option for the German climate protection strategy?], Jülich, Forschungszentrum Jülich GmbH, System Research and Technological Development.
[5] NAZARKO, J., KUCKSHINRICHS, W., SCHREIBER, A. & ZAPP, P. (2006) Umweltauswirkungen von CO₂-Abtrennung und -Speicherung als Komponente einer ganzheitlichen Technikbewertung [Environmental impact of CO₂ separation and storage as a component of an integral technology assessment], IN TECHNICAL UNIVERSITY GRAZ-INSTITUTE FOR ELECTRICITY SUPPLY INDUSTRY AND ENERGY INNOVATION (Ed.) 9th Symposium on Energy Innovation “Dritte Energiepreiskrise—Anforderungen an die Energieinnovation [Third energy cost crisis—Requirements for energy innovation]”, Graz, Austria, TU Graz.
[6] NAZARKO, J., SCHREIBER, A., KUCKSHINRICHS, W. & ZAPP, P. (2007) Environmental Analysis of the Coal-based Power Production with Amine-based Carbon Capture, IN RIS0 NATIONAL LABORATORY (Ed.) Riso International Energy Conference 2007 “Energy Solutions for sustainable development”, Riso, Denmark, Riso National Laboratory.
[7] OHLE, A., MOLLEKOPF, N., BURCHHARDT, U. & SNELL, A. (2004) Vergleich verschiedener Verfahren zur CO₂ Abscheidung aus Rauch-und Synthesegasen [Comparison of different methods for CO₂ separation from flue and synthetic gases]. XXXVI. Kraftwerkstechnisches Kolloquium—Entwicklungspotentiale für Kraftwerke mit fossilen Brennstoffen [Power Generating Technology Colloqium—Development potentials for power plants using fossil fuels], Dresden, Technical University Dresden, Institute for Energy Technology, Department for Power Generating Technologies.
[8] RAO, A. B., RUBIN, E. S. & BERKENPAS, M. B. (2004) An integrated modeling framework für carbon management technologies. Volume 1−Technical Dokumentation: Amine-Based CO₂ Capture and Storage Systems for Fossil Fuel Power Plant Pittsburgh, Carnegie Mellon University, Center for Energy and Environmental Studies/Department of Engineering and Public Policy.
[9] RÖDER, A., BAUER, C. & R., D. (2004) Kohle, IN DONES, R. (Ed.) Sachbilanzen von Energiesystemen: Grundlagen für den ökologischen Vergleich von Energiesystemen und den Einbezug von Energiesystemen in Ökobilanzen für die Schweiz [Life cycle inventory analyses of energy systems: Fundamentals for the ecological comparison of energy systems and the inclusion of energy systems in life cycle assessments for Switzerland], Dübendorf, Paul Scherrer Institute Villigen, Swiss Centre for Life Cycle Inventories.
[10] SMEISER, S. C, STOCK, R. M., MCCLEARY, G. J., BOORAS, G. S. & STUART, R. J. (1991) Engineering and Economic Evaluation of CO₂ Removal from Fossil-Fuel-Fired Power Plants

1.-12. (canceled)

13. A method for separating carbon dioxide from a flue gas using a membrane, the flue gas undergoing a flue gas scrubbing step, wherein the separation of the carbon dioxide from the flue gas is carried out before a desulfurization step of the flue gas, and that the flue gas is at such a temperature that it is not saturated with water vapor before entering the membrane.

14. The method according to claim 13, wherein the separation of the carbon dioxide is carried out after the step of nitrogen oxide reduction or dedusting of the flue gas.

15. A method according to claim 13, wherein the flue gas is at temperatures above 110° C. before entering the membrane module.

16. A method for separating carbon dioxide from a flue gas using a membrane, wherein the separation of the carbon dioxide from the flue gas is carried out after a step of desulfurizing the flue gas, and that the flue gas is heated in a separate step so that it is at a temperature at which it is not saturated with water vapor before entering the membrane module.

17. The method according to claim 16, wherein the separate heating step is carried out using a heat exchanger or a burner.

18. The method according to claim 16, wherein the separate heating step is carried out by compressing the flue gas.

19. A device for separating carbon dioxide from a flue gas, comprising a means for desulfurizing a flue gas and a membrane module having a membrane for CO₂ separation, wherein the membrane module is positioned upstream of the means for desulfurizing the flue gas, in terms of the flow.

20. The device according to claim 19, comprising a means for nitrogen oxide reduction or dedusting of the flue gas, wherein the membrane module is positioned downstream of the means for nitrogen oxide reduction or dedusting of the flue gas, in terms of flow.

21. A device for separating carbon dioxide from a flue gas, comprising at least one means for desulfurizing a flue gas and a membrane module having a membrane for CO₂ separation, wherein the membrane module is positioned downstream of the means for desulfurizing the flue gas, in terms of flow, and in that a means for heating the flue gas to such temperatures that it is not saturated with water vapor is provided between the means for desulfurization and the membrane module.

22. The device according to claim 21, comprising a heat exchanger as the means for heating the flue gas.

23. The device according to claim 21, comprising a burner as the means for heating the flue gas.

24. The device according to claim 21, comprising a compressor as the means for heating the flue gas.
